(19) United States
(12) Patent Application Publication
(10) Pub. No.: US 2026/0074238 A1
(43) Pub. Date: Mar. 12, 2026

(54) Metal Film and Method of Manufacturing the Metal Film

(71) Applicant: SK On Co., Ltd., Seoul (KR)

(72) Inventors: Chang Mook HWANG, Daejeon (KR); Hyun Ji KIM, Daejeon (KR); Jong Hyeok LEE, Daejeon (KR); Yoon Ji JO, Daejeon (KR)

(21) Appl. No.: 19/318,509

(22) Filed: Sep. 4, 2025

(30) Foreign Application Priority Data
Sep. 11, 2024 (KR) 10-2024-0124029
Aug. 29, 2025 (KR) 10-2025-0122482

(51) Int. Cl. H01M 4/70; C25D 3/38; C25D 3/44; H01M 4/66

(52) U.S. Cl. CPC H01M 4/70; C25D 3/38; C25D 3/44; H01M 4/661; H01M 4/667

(57) ABSTRACT

The present disclosure can minimize the problem that the inner and outer surfaces deteriorate due to stress caused by compression and stress caused by elongation, respectively, during bending. Furthermore, the present disclosure can prevent surface cracking and lithium precipitation due to stresses applied during bending. Furthermore, the present disclosure can improve the problem of different electrode densities on the inner and outer surfaces. Furthermore, the present disclosure can prevent a reduction in the lifetime of the battery.

### CROSS-REFERENCE TO RELATED PATENT APPLICATION

The present application claims priority under 35 U.S.C. § 119(a) to Korean patent application number 10-2024-0124029 filed on Sep. 11, 2024 and Korean patent application number 10-2025-0122482 filed on Aug. 29, 2025 in the Korean Intellectual Property Office, the entire disclosure of which is incorporated by reference herein.

### BACKGROUND OF THE INVENTION

### 1. Field

The present disclosure relates to a metal film and a method of manufacturing a metal film. The present disclosure also relates to an electrode comprising the metal film and a battery comprising the electrode. The present disclosure also relates to a method of manufacturing the electrode and battery.

### 2. Description of the Related Art

Recently, the demand for mobile devices such as smartphones, tablet PC, and wireless earphones has been increasing. In addition, with the development of electric vehicles, storage batteries for energy storage, robots, satellites, etc. in full swing, research on high-performance secondary batteries capable of repeated charging and discharging as an energy source is actively underway.

Currently, commercialized rechargeable batteries include nickel-cadmium batteries, nickel-hydrogen batteries, nickel-zinc batteries, and lithium rechargeable batteries. Among them, lithium rechargeable batteries are attracting attention for their advantages over nickel-based rechargeable batteries in that they have almost no memory effect, allowing for free charging and discharging, extremely low self-discharge rates, and high energy density.

On the other hand, the rolling method and electroplating method are widely recognized as the methods for manufacturing the current collector. The rolling method is a method that produces the capacitor in the form of a thin film sheet by applying physical force. The electroplating method is a method of preparing a current collector by immersing a drum, which serves as a negative electrode, in an electrolyte solution and peeling off a thin film sheet of metal that precipitates on the drum. In particular, the electroplating method is adopted mainly because it can secure excellent productivity while exhibiting good physical properties. Prior art references 1 and 2 disclose a method of manufacturing a current collector using the electroplating method.

### PRIOR ART REFERENCES

Prior art reference 1: KR Patent Application Publication No. 10-2014-0023955, lithium ion secondary cell, current collector constituting negative electrode of secondary cell, and electrolytic copper foil constituting negative-electrode current collector.
Prior art reference 2: KR Patent Publication No. 10-2037846, method for manufacturing electrolytic aluminum foil.

The present disclosure may provide a metal film and a manufacturing method for the metal film that minimizes the problem of deterioration of an inner and outer surface due to stress caused by compression and stress caused by elongation, respectively, when bending. Further, the present disclosure may provide a metal film and a method of manufacturing the metal film that can prevent cracking of the surface and lithium precipitation due to stresses applied during bending. Further, the present disclosure may provide a metal film and a method of manufacturing the metal film that improves the problem of different electrode densities on the inner and outer surfaces. The disclosure may also provide a metal film and a method of manufacturing the metal film that can prevent a reduction in the lifetime of a battery. The present disclosure may also provide an electrode using the metal film as a current collector and a battery comprising the electrode, and a method for manufacturing the electrode and battery.

The metal film and the method of manufacturing the metal film according to one aspect of the present disclosure can be widely applied in the field of green technology, such as electric vehicles, battery charging stations, and other solar and wind power generation utilizing batteries. Furthermore, the metal film according to one aspect of the present disclosure and the method of manufacturing the metal film can be applied to the manufacturing process of batteries used in eco-friendly electric vehicles or hybrid vehicles to prevent climate change by suppressing air pollution and greenhouse gas emissions.

Meanwhile, the present disclosure can be widely applied to electric vehicles, battery charging stations, energy storage systems (ESS), and other green technology fields such as photovoltaics and wind power using battery cells. In addition, the electrode assembly according to the present disclosure and the battery cell including the same can be used for eco-friendly mobility and the like including electric vehicles and hybrid vehicles for preventing climate change by suppressing air pollution and greenhouse fluid emission.

### SUMMARY OF THE INVENTION

A metal film according to an embodiment of the present disclosure may comprise: a first surface; and a second surface opposite to the first surface; wherein the metal film has RaR defined by the following Equation 1 in the range of 100 to 2,000,

RaR=Ra₁/Ra₂×100, [Equation 1]
where the Ra₁ denotes the arithmetic mean roughness of the first surface and the Ra₂ denotes the arithmetic mean roughness of the second surface.

In an embodiment, the metal film may be included in the current collector of a battery.

In an embodiment, the metal film may have a tensile strength in the range of 10 kg/cm² to 100 kg/cm².

In an embodiment, the metal film may have a bending number of at least 3,000 times until fracture.

In an embodiment, the metal film may further comprise a halogen element.

In an embodiment, the halogen element may comprise at least one selected from the group consisting of chlorine and iodine.

In an embodiment, the metal film may comprise chlorine in the range of 1 wt % to 30 wt % by total weight.

In an embodiment, the metal film may comprise iodine in the range of 0.001 wt % to 0.1 wt % by total weight.

In an embodiment, crystal grains may be formed on the first and second surfaces.

In an embodiment, the metal film may further comprise copper or aluminum.

A method of manufacturing a metal film according to another embodiment of the present disclosure may comprise: a step of contacting at least a portion of a metal sheet including a first surface and a second surface opposite to the first surface with a first electrolyte solution containing metal ions and withdrawing out the metal film; wherein the metal film may have Ra_{R} defined by the following Equation 1 in the range of 100 to 2,000,

Ra_{R}=Ra₁/Ra₂×100, [Equation 1]
where the Ra₁ denotes the arithmetic mean roughness of a first surface of the metal film and the Ra₂ denotes the arithmetic mean roughness of a second surface of the metal film.

In another embodiment, the first surface of the metal sheet may react with the first electrolyte solution.

In another embodiment, the second surface of the metal sheet may be not substantially reactive with the first electrolyte solution.

In another embodiment, the metal ions contained in the first electrolyte solution may be aluminum ions or copper ions, the first electrolyte solution may further comprise at least one selected from the group consisting of chlorine ions and iodine ions.

In another embodiment, the first electrolyte solution may comprise chlorine ions in the range of 0.1 mg/L to 1 mg/L.

In another embodiment, the first electrolyte solution may comprise iodine ions in the range of 1 mg/L to 10 mg/L.

In another embodiment, the metal sheet may be prepared by electroplating with a second electrolyte solution containing metal ions.

In another embodiment, the second electrolyte solution may further comprise gelatin.

An electrode according to another embodiment of the present disclosure may comprise a current collector, and an active material layer formed on at least one surface of the current collector; wherein the current collector may comprise the metal film described above.

A battery according to another embodiment of the present disclosure may comprise an electrode and a separator, wherein the electrode may comprise any of the electrodes described above.

An electric vehicle according to another embodiment of the present disclosure may comprise the cell described above.

The present disclosure can minimize the problem that the inner and outer surfaces deteriorate due to stress caused by compression and stress caused by elongation, respectively, during bending. Furthermore, the present disclosure can prevent surface cracking and lithium precipitation due to stresses applied during bending. Furthermore, the present disclosure can improve the problem of different electrode densities on the inner and outer surfaces. Furthermore, the present disclosure can prevent a reduction in the lifetime of the battery.

### BRIEF DESCRIPTION OF THE DRAWINGS

FIG. 1 is a diagram illustrating a structure of at least a portion of a jelly roll.

FIG. 2 is a diagram illustrating the structure of at least a portion of a negative electrode.

FIG. 3 is an example of at least a portion of a metal film according to one embodiment of the present disclosure.

FIG. 4 is a diagram illustrating the manufacturing process of a metal film according to one embodiment of the present disclosure.

### DETAILED DESCRIPTION

In the present disclosure, where the measurement temperature affects a property, the property is the property measured at room temperature, unless otherwise specified.

As used herein, room temperature may mean a natural, unheated or uncooled temperature, for example, any temperature within the range of 10° C. to 30° C., such as a temperature of about 15° C. or more, about 18° C. or more, about 20° C. or more, about 23° C. or more, about 27° C. or less, or 25° C. Unless otherwise specified in this disclosure, the unit of temperature is Celsius (° C.).

When referring to a property in this disclosure where the pressure at which the property is measured affects the property, the property is measured at normal pressure, unless otherwise specified.

As used herein, the term normal pressure refers to atmospheric pressure in its natural, unpressurized state, typically in the range of about 700 mmHg to 800 mmHg.

As used in the present disclosure, the terms A and B include A and B and mean within the range between A and B. For example, “comprising A and B by weight” is equivalent to comprising within the range of A and B by weight.

As used herein, the term film refers to a sheet having a thickness of about 1 mm or less. Furthermore, the film may be referred to as a foil, provided that it meets the aforementioned thickness range, and its shape is not particularly restricted.

A lithium secondary battery generally includes a positive electrode comprising a positive electrode active material, a negative electrode comprising a negative electrode active material, a separator that enables the movement of lithium ions between the positive electrode and the negative electrode and prevents shorting, and an electrolyte that enables the movement of lithium ions. The term electrode is defined herein to include the positive electrode and the negative electrode. Further, the structure comprising the positive electrode, negative electrode and separator is defined as an electrode assembly.

Lithium secondary batteries primarily utilize lithium-based oxides as the positive electrode active material and carbon materials as the negative electrode active material. Furthermore, the positive electrode and the negative electrode can be prepared by applying an electrode slurry comprising a positive electrode active material or a negative electrode active material, respectively, onto a current collector in the form of a metal plate and then drying it.

Furthermore, lithium secondary batteries are categorized into lithium ion batteries using liquid electrolyte and lithium polymer batteries using polymer electrolyte based on the type of electrolyte. Furthermore, lithium secondary batteries can be broadly categorized into cylindrical, prismatic, and pouch type.

On the other hand, the electrode assembly is a wound electrode assembly with a wound structure in which a separator is positioned between the positive electrode and negative electrode in the form of a sheet, Stacked electrode assemblies, which are sequentially stacked with a separator between the positive electrode and negative electrode cut in predetermined size units, and stacked/folded electrode assemblies, which are stacked with a separator between the positive electrode and negative electrode cut in predetermined size units, and bi-cells or full cells, which are folded in a unidirectional or zigzag direction using a long length of continuous separator sheet.

Such electrode assemblies are commonly referred to as jelly rolls due to their resemblance to the shape of winding jelly.

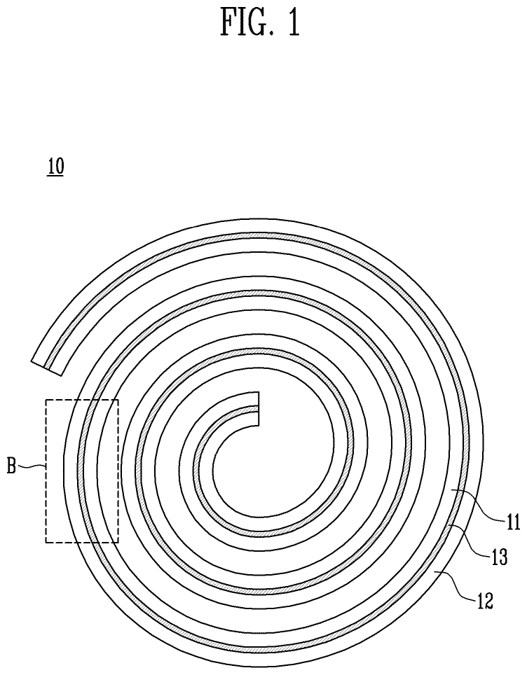

FIG. 1 is a diagram illustrating a structure of at least a portion of a jelly roll. That is, it is a simplified illustration of an electrode assembly 10 in the form of a jelly roll. Referring to FIG. 1, it can be seen that the jelly roll is formed by sequentially stacking a positive electrode 11, a separator 13 and a negative electrode 12 and then winding them.

The jelly roll-shaped electrode assembly 10 obtained by stacking the sheet-shaped positive electrode 11, separator 13, and negative electrode 12 in sequence and winding them, inevitably has a bending portion. For example, the bending portion may refer to portion B in FIG. 1.

The bending portion has an inner surface IS subjected to stress by compression and an outer surface IO subjected to stress by extension. The inner and outer surfaces are subjected to deterioration due to different mechanisms.

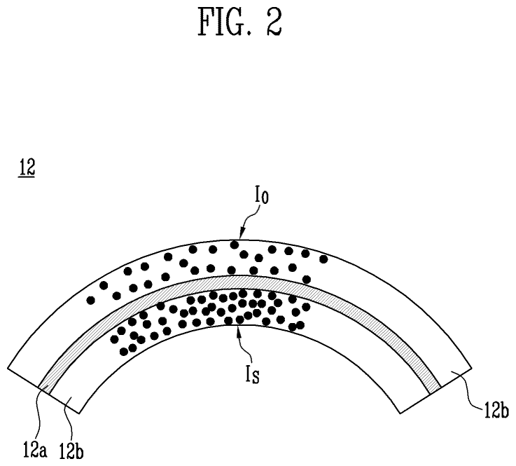

FIG. 2 is a diagram illustrating the structure of at least a portion of a negative electrode 12.

Referring to FIG. 2, the negative electrode 12 may comprise an active material layer 12b on both surfaces of the current collector 12a. However, by way of illustration only, the negative electrode 12 may have the active material layer 12b on a single surface of the current collector 12a. Referring to FIG. 2, the negative electrode 12 is shown bending, wherein the bending forms an inner surface IS stressed by compression and an outer surface IO stressed by elongation. Although the negative electrode 12 is illustrated, the same is true for the positive electrode 11.

Thus, a battery according to the present disclosure may comprise the positive electrode 11, the negative electrode 12, and the separator 13.

Such deterioration may result in cracks on the surface of the electrode assembly and lithium plating in certain areas. Furthermore, the deterioration may reduce the lifetime of the battery after repeated cycles by 30% or more from the initial value.

Furthermore, the positive electrode or the negative electrode includes an active material layer formed by the electrode slurry on the current collector, and by bending, the density of the active material in the active material layer increases on the inner surface and the density of the active material decreases on the outer surface. This may result in different densities of the electrodes on the inner and outer surfaces. Referring to FIG. 2, it can be seen that the density of the active material decreases on the outer surface IO due to elongation, and the density of the active material increases on the inner surface IS due to compression.

In particular, the negative electrode is usually subjected to repeated volume expansion and contraction by charging and discharging, and is subjected to forces due to volume expansion and contraction in addition to the stress generated by bending. If the inner and outer electrode densities are different, the difference in force due to the expansion of the inner and outer electrode may cause the curled negative electrode to straighten. This phenomenon can cause problems such as electrical short circuits and lithium precipitation.

The metal film 100 according to one example of the present disclosure may include a first surface 100a and a second surface 100b. The second surface 100b may be opposite to the first surface 100a. The shape of the metal film 100 is not particularly limiting, provided that the metal film 100 comprises a first surface 100a and a second surface 100b that is opposite to the first surface 100a.

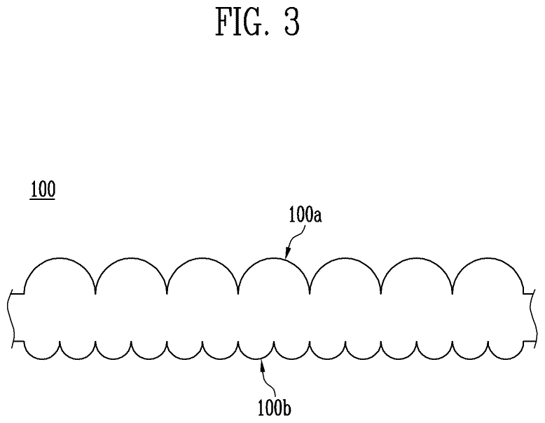

FIG. 3 is an example of at least a portion of a metal film 100 according to one embodiment of the present disclosure. Referring to FIG. 3, the metal film 100 includes a first surface 100a and a second surface 100b, which is opposite to the first surface.

Furthermore, the metal film 100 may be a current collector of a battery. The current collector may be a positive electrode current collector in the case of a positive electrode, or a negative electrode current collector in the case of a negative electrode. The type, size, and shape of the positive electrode current collector is not particularly limited, as long as it is conductive without causing chemical changes in the battery. The positive electrode current collector may be, for example, stainless steel, aluminum, nickel, titanium, calcined carbon, or aluminum or stainless steel surface treated with carbon, nickel, titanium, or silver. The type, size, and shape of the negative electrode current collector is not particularly limited, as long as it is conductive without causing chemical changes in the battery. For example, copper, stainless steel, aluminum, nickel, titanium, calcined carbon, a surface treatment of copper or stainless steel with carbon, nickel, titanium, silver, or the like, an aluminum-cadmium alloy, and the like may be used as the negative electrode current collector.

The metal film 100 according to one example of the present disclosure may comprise copper or aluminum. The metal film 100 may comprise copper in an amount of 55 wt % or more by weight, 60 wt % or more by weight, 70 wt % or more by weight, 75 wt % or more by weight, 80 wt % or more by weight, 85 wt % or more by weight, 90 wt % or more by weight, or 95 wt % or more by total weight of the metal film 100. Further, the metal film 100 may comprise aluminum in an amount of at least 55 wt % or more, 60 wt % or more, 70 wt % or more, 75 wt % or more, 80 wt % or more, 85 wt % or more, 90 wt % or more, or 95 wt % or more, based on the total weight of the metal film 100. If the metal film 100 comprises copper satisfying a content in the above range, it may be used as a negative electrode current collector. Further, if the metal film 100 comprises aluminum with a content in the above range, it may be used as a positive electrode current collector.

The metal film 100 according to one example of the present disclosure may comprise halogen elements. As used herein, a halogen element is an element corresponding to group 17 of the periodic table, such as fluorine, chlorine, bromine, and iodine. By including halogen elements, the metal film 100 can minimize the problem of deterioration of the inner and outer surfaces due to compressive and elongation stresses, respectively, during bending.

The metal film 100 according to one example of the present disclosure may comprise one or more of the halogen elements selected from the group consisting of chlorine and iodine. By including at least one selected from the group consisting of chlorine and iodine, the metal film 100 can minimize the problem of deterioration of the inner and outer surfaces, respectively, due to stress caused by compression and stress caused by elongation during bending.

The metal film 100 according to one example of the present disclosure may comprise chlorine among the halogen elements. The metal film 100 may comprise chlorine in an amount of 1 wt % or more, 2 wt % or more, 3 wt % or more, 4 wt % or more, 5 wt % or more, 6 wt % or more, 7 wt % or more, 8 wt % or more, 9 wt % or more, 10 wt % or more, 11 wt % or more, or 12 wt % or more, based on its total weight. Further, the metal film 100 may comprise chlorine in an amount of 30 wt % or less, 28 wt % or less, 26 wt % or less, 24 wt % or less, 22 wt % or less, 20 wt % or less, or 18 wt % or less, based on its total weight. Further, the chlorine may be contained within a range formed by appropriately adopting the aforementioned upper and lower limits. Including the chlorine within the above content ranges can minimize the problem of deterioration of the inner and outer surfaces due to stress by compression and stress by elongation, respectively, during bending.

The metal film 100 according to one example of the present disclosure may comprise iodine among the halogen elements. The metal film 100 may comprise iodine in an amount of 0.001 wt % or more, 0.005 wt % or more, 0.01 wt % or more, 0.015 wt % or more, or 0.02 wt % or more, based on its total weight. Further, the metal film 100 may comprise iodine in an amount of 0.1 wt % or less, 0.09 wt % or less, 0.08 wt % or less, 0.07 wt % or less, 0.06 wt % or less, 0.05 wt % or less, 0.04 wt % or less, or 0.03 wt % or less, based on its total weight. Further, the iodine may be contained within a range formed by appropriately adopting the upper and lower limits described above. Including the iodine within the above content range can minimize the problem of deterioration of the inner and outer surfaces due to stress caused by compression and stress caused by elongation, respectively, during bending.

The metal film 100 according to one example of the present disclosure may be a rolled metal film 100 or an electrolyzed metal film 100. As used herein, the term rolled metal film 100 refers to a metal film 100 manufactured by rolling. Also, as used herein, the term electrolyzed metal film 100 refers to a metal film 100 prepared by electroplating.

The metal film 100 according to one example of the present disclosure may preferably be an electrolyzed metal film 100. Manufacturing the metal film 100 by an electroplating method enables the metal film 100 to exhibit good physical properties while securing excellent productivity.

The metal film 100 according to one example of the present disclosure may have crystal grains formed on the first surface 100a and the second surface 100b. The metal film 100 may have crystal grains formed on the first surface 100a and the second surface 100b by manufacturing the metal film 100 according to the manufacturing method of the metal film 100 to be described later. The crystal grains may be formed when manufactured by an electroplating method.

The metal film 100 according to one example of the present disclosure may have a roughness satisfying a certain numerical range due to the grains. The metal film 100 may have irregularities formed on its surface to have a roughness satisfying a certain numerical range.

The first surface 100a and the second surface 100b of the metal film 100 according to one example of the present disclosure may each independently have a roughness satisfying a certain numerical range. Furthermore, the first surface 100a and the second surface 100b of the metal film 100 may have different roughness. The degree to which the first surface 100a and the second surface 100b have different roughness may be represented by a Ra_{R} value according to Equation 1 below.

The metal film 100 according to one example of the present disclosure may have a Ra_{R} according to Equation 1 of 100 or more, 101 or more, 102 or more, 103 or more, 104 or more, 105 or more, 106 or more, 107 or more, 108 or more, 109 or more, or 110 or more, or 2,000 or less, 1,900 or less, 1,800 or less, 1,700 or less, 1,600 or less, 1,500 or less, 1,400 or less, 1,300 or less, 1,200 or less, 1,100 or less, or 1,000 or less. Ra_{R} according to Equation 1 below may be within a range formed by appropriately selecting the aforementioned upper and lower limits.

Ra_{R}=Ra₁/Ra₂×100 [Equation 1]

In Equation 1, Ra₁ denotes the arithmetic mean roughness (unit: μm) of the first surface 100a, and Ra₂ denotes the arithmetic mean roughness (unit: μm) of the second surface 100b.

As used herein, the term arithmetic mean roughness Ra is also referred to as centerline mean roughness. The arithmetic mean roughness may be measured by drawing a roughness curve formed on the face of the object to be measured, drawing a mean amplitude line (center line) about a reference length L, and then measuring the average value of the deviation of all peaks and valleys deviating from the mean amplitude line. More specifically, the arithmetic mean roughness may be measured according to ISO4287:1997.

The metal film 100 according to one example of the present disclosure can minimize the problem of deterioration of the inner and outer surfaces respectively due to stresses caused by compression and elongation during bending by satisfying Ra_{R} according to Equation 1 within the above range, and can prevent the occurrence of cracks on the surface and lithium precipitation phenomena due to stresses acting during bending, and can prevent a reduction in the service life of the battery.

The metal film 100, according to one example of the present disclosure, may be used as a current collector and included in an electrode assembly. The electrode assembly may be formed into a jelly roll by winding. Due to the winding, at least a portion of the electrode assembly is bent and the bending results in the formation of an inner surface stressed by compression and an outer surface stressed by elongation.

The metal film 100 according to one example of the present disclosure can improve the problem that the electrode density of the inner surface and the outer surface varies due to bending by satisfying a value within the range of Rap according to Equation 1 above.

The first surface 100a of the metal film 100 according to one example of the present disclosure may have a larger roughness than the second surface 100b. Here, the first surface 100a of the metal film 100 may be an outer surface subjected to stress due to stretching due to the bending, and the second surface 100b may be an inner surface subjected to stress due to compression due to the bending.

In the metal film 100 according to one example of the present disclosure, by making the first surface 100a, which has a relatively large roughness, subject to stress by stretching, and the second surface 100b, which has a smaller roughness compared to the first surface 100a, subject to stress by compression, the problem of deterioration of the inner and outer surfaces due to stress by compression and stress by stretching, respectively, during bending can be minimized, and cracking of the surface and lithium precipitation phenomena due to stress acting during bending can be prevented, and a reduction in the life of the battery can be prevented.

The metal film 100 according to one example of the present disclosure has Ra₁ of Equation 1 wherein Ra₁ is 0.1 μm or more, 0.101 μm or more, 0.102 μm or more, 0.103 μm or more, 0.104 μm or more, 0.105 μm or more, 0.106 μm or more, 0.107 μm or more, 0.108 μm or more, 0.109 μm or more, or 0.11 μm or more, or 2 μm or less, 1.9 μm or less, 1.8 μm or less, 1.7 μm or less, 1.6 μm or less, 1.5 μm or less, 1.4 μm or less, 1.3 μm or less, 1.2 μm or less, 1.1 μm or less, or 1 μm or less. Ra₁ of Equation 1 may be within a range formed by appropriately selecting the aforementioned upper and lower limits. If Ra₁ is within the range described above, it is possible to maintain excellent adhesion with the active material layer while preventing the problem of deterioration and cracking due to stress caused by elongation during bending.

The metal film 100 according to one example of the present disclosure may have Ra₂ in Equation 1 of 0.01 μm or more, 0.02 μm or more, 0.03 μm or more, 0.04 μm or more, or 0.05 μm or more, or 0.5 μm or less, 0.45 μm or less, 0.4 μm or less, 0.35 μm or less, 0.3 μm or less, 0.25 μm or less, 0.2 μm or less, 0.15 μm or less, or 0.1 μm or less. Ra₂ of Equation 1 may be within a range formed by appropriately selecting the aforementioned upper and lower limits. If Ra₂ is within the range described above, it is possible to maintain excellent adhesion with the active material layer while preventing deterioration due to stress caused by compression during bending.

The metal film 100 according to one example of the present disclosure may have a tensile strength of 10 kg/cm² or more, 15 kg/cm² or more, 20 kg/cm² or more, 25 kg/cm² or more, or 30 kg/cm² or more, or 100 kg/cm² or less, 95 kg/cm² or less, 90 kg/cm² or less, 85 kg/cm² or less, or 80 kg/cm² or less. The tensile strength may be within a range formed by appropriately selecting the aforementioned upper and lower limits. The tensile strength may be a value measured at 25° C. without any pretreatment of the metal film 100. The tensile strength may be measured by tensile testing, for example by fabricating specimens in the form of ASTM E345, Standard Specification for Tensile Testing of Metal Thin Films.

The metal film 100 according to one example of the present disclosure may have a bending number of at least 3,000 times until fracture. More specifically, it may be from 3,000 times to 10,000 times. The bending number may be a value measured at 25° C. without any pretreatment to the metal film 100. The bend recovery may be measured using a proof bend test. The flexural test may be to make the metal film 100 into a rectangular sample having a width of 10 mm and a length of 10 mm and to measure the flexural recovery until fracture is reached with a flexure testing machine, specifically, flexural radius: 1 mm, flexural speed: 100 cpm, stroke: 20 mm, according to the measurement method of JIS C5016.

The metal film 100 according to one example of the present disclosure may have a thickness of 1 μm or more, 1.5 μm or more, 2 μm or more, 2.5 μm or more, 3 μm or more, 3.5 μm or more, 4 μm or more, 4.5 μm or more, 5 μm or more, 5.5 μm or more, or 6 μm or more, or 500 μm or less, 450 μm or less, 400 μm or less, 350 μm or less, 300 μm or less, 250 μm or less, 200 μm or less, 150 μm or less, 100 μm or less, 50 μm or less, 40 μm or less, 30 μm or less, 20 μm or less, or 10 μm or less, or it may be a range formed by specifying the upper and lower limits described above.

The metal film 100 according to one example of the present disclosure may be manufactured by the method for manufacturing the metal film 100 described hereinafter.

The method of manufacturing the metal film 100 according to one example of the present disclosure includes a step of withdrawing out the metal film 100 by contacting a metal sheet 200 including a first surface 200a and a second surface 200b at least partially to a first electrolyte solution 120 comprising metal ions. The second surface 200b of the metal sheet 200 may be opposite to the first surface 200a. Here, the metal film 100 refers to a state after the metal sheet 200 has been treated with the first electrolyte solution 120. A first surface 200a of the metal sheet 200 corresponds to the first surface 100a of the metal film 100, and a second surface 200b of the metal sheet 200 corresponds to the second surface 100b of the metal film 100.

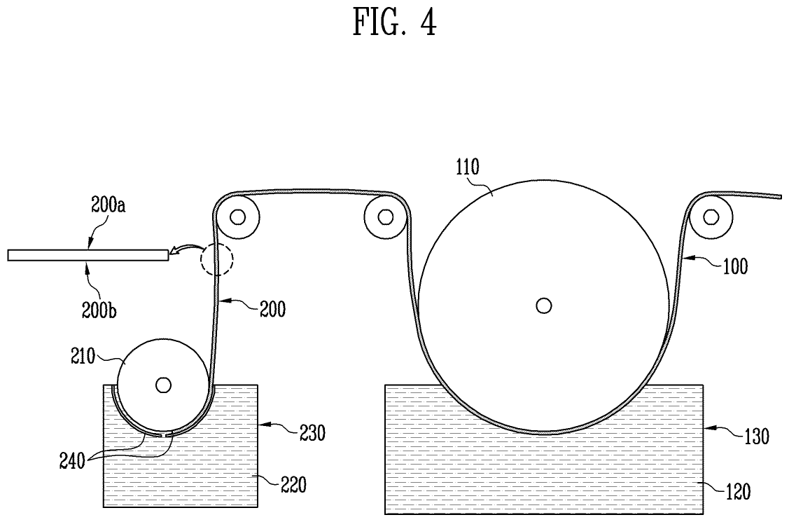

FIG. 4 is a diagram illustrating the manufacturing process of a metal film 100 according to one embodiment of the present disclosure. Referring to FIG. 4, the metal film 100 is drawn by contacting a metal sheet 200 at least partially with the first electrolyte solution 120. The metal sheet 200 may be transported through at least one or more rollers. Furthermore, the metal sheet 200 is manufactured into a metal film 100 by being transported with one surface in contact with the first drum 110 and the opposite surface not in contact with the drum 110 being in contact with the first electrolyte solution 120. The metal film 100 may be withdrawn via one or more rollers. The metal sheet 200 may be transported with at least a portion of its first surface in close contact with the first drum 110, and in other examples, with all of its first surface in close contact with the first drum 110.

In the method of manufacturing the metal film 100 according to one example of the present disclosure, the first surface 200a of the metal sheet 200 may be reacted with the first electrolyte solution 120. Further, the second surface 200b of the metal sheet 200 may be substantially not reactive with the first electrolyte solution 120.

When the first surface 200a of the metal sheet 200 reacts with the first electrolyte solution 120, it means that a physical or chemical change has occurred such that the difference in surface properties with respect to the first surface 200a is 5% or more.

The surface characteristic is not limited, but may be, for example, the amplitude length of an irregularity formed on the surface whose peak is farthest from a reference point. The reference point may refer to a mean amplitude line (centerline). In other words, the metal sheet 200 is the to react with the first electrolyte solution 120 when the difference between the amplitude length L1 of the unevenness with the peak farthest from the reference point among the unevenness formed on the surface before the metal sheet 200 reacts with the first electrolyte solution 120 and the amplitude length L2 of the unevenness with the peak farthest from the reference point among the unevenness formed on the surface after the metal sheet 200 reacts with the first electrolyte solution 120 is 5% or more.

Furthermore, when the second surface 200b of the metal sheet 200 substantially does not react with the first electrolyte solution 120, it is meant that the second surface 200b does not react with the first electrolyte solution 120 at all, it is meant that a minor physical or chemical change has occurred in the surface properties of the second surface 200b such that the difference in surface properties is 5% or less. In other words, substantially does not react includes not reacting at all, as well as minor changes occurring due to natural contact rather than reacting as intended. For example, the metal sheet 200 may be the to be substantially not reactive with the first electrolyte solution 120 when the difference between the amplitude length L1 of the unevenness farthest from the reference point among the unevenness formed on the surface before the metal sheet 200 reacts with the first electrolyte solution 120 and the amplitude length L2 of the unevenness farthest from the reference point among the unevenness formed on the surface after the metal sheet 200 reacts with the first electrolyte solution 120 is 5% or less.

Referring to FIG. 4, the metal sheet 200 may be conveyed with one surface in contact with the first drum 110. A second surface 200b of the metal sheet 200 may be in contact with the first drum 110, and a first surface 200a of the metal sheet 200 may be in contact with the first electrolyte solution 120. In this manner, the first surface 200a of the metal sheet 200 reacts with the first electrolyte solution 120 and the second surface 200b excludes as much as possible the reaction with the first electrolyte solution 120, thereby producing a metal film 100 having different roughness of the first surface 100a and the second surface 100b.

In the method of manufacturing the metal film 100 according to one example of the present disclosure, the second surface 200b of the metal sheet 200 is preferably pressed against the first drum 110. By closely pressing the second surface 200b of the metal sheet 200 to the first drum 110, the reaction between the second surface 200b and the first electrolyte solution 120 can be prevented as much as possible.

Referring to FIG. 4, in the method of manufacturing the metal film 100 according to one example of the present disclosure, the first electrolyte solution 120 is contained in the inner space of the first electrolytic bath 130, and the metal sheet 200 can be brought into at least partial contact with the first electrolyte solution 120 via the first drum 110.

In the method of manufacturing the metal film 100 according to one example of the present disclosure, the first electrolyte solution 120 may comprise metal ions. The metal ions may be ions of a metal contained in the metal sheet 200. In another example, the metal ions may be ions of a major component metal contained in the metal sheet 200. As used herein, the term major component metal may refer to a metal that is contained in 55 wt % or more by total weight of the metal in the total composition. As used herein, the term major component may refer to a component that is contained in 55 wt % or more by weight of the total composition.

The metal ions comprised by the first electrolyte solution 120 may be ions of an ionizable metal that can be used as a positive electrode current collector or a negative electrode current collector. Specifically, the metal ions may be present in the ionic state in an aqueous solution. In one example, the metal ions comprised by the first electrolyte solution 120 may be aluminum ions or copper ions. Furthermore, in one example, the copper ions contained in the first electrolyte solution 120 may have a concentration of about 50 g/L to 100 g/L.

In the method of preparing the metal film 100 according to one example of the present disclosure, the first electrolyte solution 120 may comprise ions of halogen elements. Specifically, the first electrolyte solution 120 may include one or more of the halogen elements selected from the group consisting of chlorine ions and iodine ions, in order to differentiate the surface properties between the first surface 200a and the second surface 200b of the metal sheet 200.

In the method of manufacturing the metal film 100 according to one example of the present disclosure, the first electrolyte solution 120 may comprise chlorine ions. The first electrolyte solution 120 may include a concentration of chlorine ions such that the concentration of chlorine ions in range of 0.1 mg/L to 1 mg/L. By including chlorine ions with a concentration within the above range, the first electrolyte solution 120 can produce a metal film 100 that can minimize the problem of deterioration of the inner and outer surfaces, respectively, due to stress caused by compression and stress caused by elongation during bending.

In the method of manufacturing the metal film 100 according to one example of the present disclosure, the first electrolyte solution 120 may include iodine ions. The first electrolyte solution 120 can include iodine ions at a concentration of 1 mg/L or more, 1.5 mg/L or more, 2 mg/L or more, 2.5 mg/L or more, 3 mg/L or more, 3.5 mg/L or more, 4 mg/L or more, 4.5 mg/L or more, or 5 mg/L or more. In another example, the first electrolyte solution 120 may comprise such that the concentration of iodine ions is 10 mg/L or less, 9.5 mg/L or less, 9 mg/L or less, 8.5 mg/L or less, 8 mg/L or less, 7.5 mg/L or less, 7 mg/L or less, 6.5 mg/L or less, 6 mg/L or less, or 5.5 mg/L or less. In other examples, the first electrolyte solution 120 may cause the concentration of the iodine ions to be within a range appropriately selected from the aforementioned upper and lower limits.

By having the first electrolyte solution 120 include iodine ions with a concentration within the range, a metal film 100 can be produced that can minimize the problem of deterioration of the inner and outer surfaces, respectively, due to stresses caused by compression and stresses caused by elongation during bending.

In a method of manufacturing the metal film 100 according to one example of the present disclosure, the first electrolyte solution 120 may include electrolyte ions that act as an electrolyte. The electrolyte ions may be bystander ions that do not participate in the physical or chemical reactions of the metal ions or halogen ions contained in the first electrolyte solution 120. Any ion having the above characteristics may be used without limitation, but for example, the first electrolyte solution 120 may comprise sulfate ions. Further, in one example, the sulfate ions in the first electrolyte solution 120 may have a concentration of from 100 g/L to 150 g/L.

In the method of producing the metal film 100 according to one example of the present disclosure, the manner of obtaining the metal sheet 200 is not particularly limited. In the method of manufacturing the metal film 100, the metal sheet 200 may be prepared by electroplating with a second electrolyte solution 220 containing metal ions. The electroplating method is a method of preparing an electrolyte by placing a drum acting as a negative electrode in contact with the electrolyte solution and peeling off the metal thin film sheet precipitated on the drum. The power applied in the above electroplating method may be from about 30 A/dm² to 120 A/dm².

Referring to FIG. 4, a metal sheet 200 may be manufactured by arranging a rotating second drum 210 and an insoluble electrode plate 240 underneath it, and a second electrolyte solution 220 is positioned between the second drum 210 and the insoluble electrode plate 240. The metal sheet 200 may be manufactured by precipitating metal on the surface of the second drum 210, which is the negative electrode, and the insoluble electrode plate 240, which is the positive electrode, by passing an electric current between the second drum 210 and the insoluble electrode plate 240.

Referring to FIG. 4, in the manufacturing method of the metal film 100 according to one example of the present disclosure, the second electrolyte solution 220 is contained in the inner space of the second electrolytic bath 230, and the metal sheet 200 can be manufactured through the second drum 210 and the insoluble electrode plate 240.

In the method of manufacturing the metal film 100 according to one example of the present disclosure, the material of the second drum 210 is not particularly limited as long as it has a low bonding force with the metal sheet 200 being formed and has a natural oxide film. The material of the second drum 210 may include, for example, at least one selected from the group consisting of titanium, stainless steel, nickel, and carbon. In the method of manufacturing the metal film 100 according to one example of the present disclosure, the second drum 210 is preferably formed of titanium.

In the method of manufacturing the metal film 100 according to one example of the present disclosure, the insoluble electrode plate 240 can be made of any material that is insoluble in the second electrolyte solution 220. As used in this disclosure, insoluble means characterized by dissolving 0.01 mol or less of the material in 1 L of the solvent.

The insoluble electrode plate 240 may comprise a metal that will be included in the metal sheet 200 to be formed. Specifically, the insoluble electrode plate 240 may comprise the main component metal to be included in the metal sheet 200 to be formed. Further, the insoluble electrode plate 240 may comprise 55 wt % or more, 60 wt % or more, 65 wt % or more, 70 wt % or more, 75 wt % or more, 80 wt % or more, 85 wt % or more, 90 wt % or more, 95 wt % or more, or 99 wt % or more by weight of the main component metal to be included in the metal sheet 200 to be formed.

For example, if the main component metal of the metal sheet 200 to be formed is to be copper, the insoluble electrode plate 240 may include copper as a main component. Furthermore, if the main component metal of the metal sheet 200 to be formed is aluminum, the insoluble electrode plate 240 may include aluminum as a main component.

Further, the insoluble electrode plate 240 may be coated with a metal oxide.

In the method of manufacturing the metal film 100 according to one example of the present disclosure, the second electrolyte solution 220 may comprise metal ions. The metal ions may be selected taking into account the metal sheet 200 being formed.

The metal ions included by the second electrolyte solution 220 may be ions of a metal that is ionizable and can be used as a positive electrode current collector or a negative electrode current collector. Specifically, the metal ions may be present in an ionic state in an aqueous solution. In one example, the metal ions comprised by the second electrolyte solution 220 may be aluminum ions or copper ions. Further, in one example, the copper ions contained in the second electrolyte solution 220 may have a concentration of about 50 g/L to 100 g/L.

In the method of manufacturing the metal film 100 according to one example of the present disclosure, the second electrolyte solution 220 may comprise electrolyte ions acting as electrolytes. The electrolyte ions may be bystander ions that do not participate in the physical or chemical reactions of the metal ions contained in the second electrolyte solution 220. Any ion having the above characteristics may be used without limitation, but for example, the second electrolyte solution 220 may comprise sulfate ions. Further, in one example, the sulfate ions contained in the second electrolyte solution 220 may have a concentration of about 100 g/L to 150 g/L. In the method of manufacturing the metal film 100 according to one example of the present disclosure, the second electrolyte solution 220 may comprise gelatin. By including the gelatin, a metal sheet 200 having crystallites formed on its surface can be produced. With the metal sheet 200 having crystal grains, the metal film 100 according to one example of the present disclosure can be prepared by the process described above.

The gelatin included in the second electrolyte solution 220 may have a weight average molecular weight of from 20,000 g/mol to 160,000 g/mol. When using a gelatin having a weight average molecular weight satisfying the aforementioned range, the surface of the crystal grains can be prepared with a curved surface close to a spherical shape to secure adhesion with the subsequent active material layer.

As used herein, the weight average molecular weight (Mw) may be measured using gel permeation chromatography, more particularly according to the methods described below. Also, as used herein, the term poly dispersity index (M (w)/M (n)) means the weight average molecular weight (Mw) divided by the number average molecular weight (M (n)) and refers to the distribution of molecular weights of the polymer. The water average molecular weight (Mn) can also be measured using gel permeation chromatography if necessary.

Specifically, the weight average molecular weight or the number average molecular weight can be determined by placing the sample to be analyzed in a 5 mL vial, diluting it with tetrahydrofuran solvent to a concentration of about 1 mg/mL, filtering the calibration standard and the analyte through a syringe filter (pore size: 0.45 μm), and measuring the weight average molecular weight. Agilent technologies' ChemStation is used as the analysis program, and the elution time of the sample is compared with the calibration curve to obtain the weight average molecular weight.

<GPC measurement conditions
Instrument: 1200 series by Agilent technologies
Column: TL Mix. A & B from Agilent technologies
Solvent: tetrahydrofuran
Column temperature: 35° C.
Sample concentration: 1 mg/mL, 200 μL injection

Standard sample: polystyrene (MP: 3900000, 723000, 316500, 52200, 31400, 7200, 3940, 485)

In the method of manufacturing the metal film 100 according to one example of the present disclosure, when manufacturing the metal sheet 200, the current density between the second drum 210 and the insoluble electrode plate 240 may be in the range of 30 A/dm² to 150 A/dm².

By controlling the current density within the aforementioned range, a metal sheet 200 having a suitable thickness and strength can be manufactured.

In the manufacturing method of the metal film 100 according to one example of the present disclosure, when manufacturing the metal sheet 200, the temperature, specifically, the temperature of the second electrolyte solution 220 may be in the range of 45° C. or more to 60° C. or less. By controlling the temperature within the aforementioned range, a metal sheet 200 having a suitable thickness and strength can be manufactured.

The thickness of the metal sheet 200 according to one example of the present disclosure may be 1 μm or more, 1.5 μm or more, 2 μm or more, 2.5 μm or more, 3 μm or more, 3.5 μm or more, 4 μm or more, 4.5 μm or more, 5 μm or more, 5.5 μm or more, 6 μm or more, or 8 μm or more, or 500 μm or less, 450 μm or less, 400 μm or less, 350 μm or less, 300 μm or less, 250 μm or less, 200 μm or less, 150 μm or less, 100 μm or less, 50 μm or less, 40 μm or less, 30 μm or less, 20 μm or less, or 10 μm or less, or it may be a range formed by specifying the upper and lower limits described above.

Referring now to FIG. 4, an example of fabricating a metal film 100 comprising copper will be described through a series of steps. This is by way of illustration only and is not intended to be limiting to the present disclosure.

Referring to FIG. 4, the second electrolytic bath 230 may include a second electrolyte solution 220. The second electrolyte solution 220 may include sulfuric acid, copper ions, and gelatin. The second drum 210 is positioned in the inner space of the second electrolytic bath 230 and is configure to contact the second electrolyte solution 220. Further, an insoluble electrode plate 240 is provided at a distance not far from the second drum 210. Here, the insoluble electrode plate 240 can be a copper film coated with iridium oxide.

With the rotating second drum 210 as the negative electrode and the insoluble electrode plate 240 as the positive electrode, passing an electric current between them causes copper metal to precipitate on the surface of the second drum 210, which is the negative electrode, to produce a thin metal sheet 200. The metal sheet 200 produced in the second drum 210 can be separated and transferred to one or more rollers.

The transported metal sheet 200 is pressed against the rotating first drum 110 on a surface (second surface, 200b) and is in contact with the first electrolyte solution 120 in the first electrolytic bath 130. The surface (i.e., the first surface, 200a) of the metal sheet that is not in close contact with the first drum 110 reacts with the first electrolyte solution 120. The first electrolyte solution 120 may comprise sulfuric acid and copper ions.

Thus, a metal film 100 is produced comprising a first surface 100a reacted with the first electrolyte solution 120 and a second surface 100b substantially unreacted with the first electrolyte solution 120.

The method for producing the metal film 100 according to one example of the present disclosure enables the metal film 100 according to one example of the present disclosure to be produced. The physical characteristics of the metal film 100 are as described above.

The electrode according to one example of the present disclosure may comprise a current collector and an active material layer. The active material layer may be formed on at least one surface of the current collector, i.e., the active material layer may be formed on one or both surfaces of the current collector.

In an electrode according to one example of the present disclosure, the current collector may be a metal film according to one example of the present disclosure. By using a metal film as an electrolyte, the electrode can minimize the problem of deterioration of the inner and outer surfaces due to stress caused by compression and stress caused by elongation, respectively, during bending, thereby preventing a reduction in the life of the battery.

In an electrode according to one example of the present disclosure, the active material layer may refer to a layer formed when the slurry present on the current collector is dried and the solvent is removed, or formed by a rolling process after drying. The active material layer may have a thickness of 1 to 200 μm.

The slurry may comprise an electrode active material and a binder.

The electrode active material may comprise about 80 wt % or more, 81 wt % or more, 82 wt % or more, 83 wt % or more, 84 wt % or more, 85 wt % or more, 86 wt % or more, 87 wt % or more, or 88 wt % or more, 99 wt % or less, or 98 wt % or less, based on the total weight of the solids in the slurry.

The binder may be included in an amount of 0.1 or more parts by weight, 0.2 or more parts by weight, 0.3 or more parts by weight, 0.4 or more parts by weight, 0.5 or more parts by weight, 0.6 or more parts by weight, 0.7 or more parts by weight, 0.8 or more parts by weight, 0.9 or more parts by weight, or 1 or more parts by weight, 10 or less parts by weight, 9.5 parts by weight or less, 9 parts by weight or less, 8.5 parts by weight or less, 8 parts by weight or less, 7.5 parts by weight or less, 7 parts by weight or less, 6.5 parts by weight or less, 6 parts by weight or less, 5.5 parts by weight or less, 5 parts by weight or less, 4.5 parts by weight or less, 4 parts by weight or less, 3.5 parts by weight or less, 3 parts by weight or less, 2.5 parts by weight or less, or 2 parts by weight or less relative to 100 parts by weight of the electrode active material in order to improve adhesion to the electrode active material layer and secure the desired viscosity.

The binder is not particularly limited to a specific type, and may be any substance that generally serves to enhance adhesion between electrode active materials and adhesion between the electrode active materials and the electrode current collector.

The types of binders are not particularly limited. For example, polyvinylidene difluoride, polyvinyl alcohol, styrene butadiene rubber, polyethylene oxide, carboxyl methyl cellulose, cellulose acetate, cellulose acetate butylate, cellulose acetate butylate, cellulose acetate propionate, cyanoethylpullulan, and cyanoethyl polyvinylalcohol, cyanoethyl cellulose, cyanoethyl sucrose, pullulan, polymethylmethacrylate, polybutylacrylate, polyacrylonitrile, polyvinylpyrrolidone, polyvinylacetate, ethylene-co-vinyl acetate copolymer, polyethylene-co-vinyl acetate, polyarylate, and at least one selected from the group consisting of low molecular weight compounds having a molecular weight of 10,000 g/mol or less.

The slurry may further comprise a conductive material. The conductive material is not particularly limited as long as it is conductive without causing chemical changes in the battery. For example, the conductive material may include graphite, such as natural graphite or artificial graphite; carbon black, such as carbon black, acetylene black, Ketjenblack, channel black, Furnace black, lamp black, thermal black; conductive fibers, such as carbon fibers or metal fibers; conductive tubes, such as carbon nanotubes; metal powders, such as fluorocarbon, aluminum, nickel powder; conductive whiskers, such as zinc oxide, potassium titanate; conductive metal oxides, such as titanium oxide; conductive materials, such as polyphenylene derivatives; and the like.

The conductive material may comprise, but is not limited to, 0.1 to 5 parts by weight or 0.5 to 2 parts by weight relative to 100 parts by weight of the electrode active material. The method of determining the content of the coating material to an appropriate level, taking into account the cycle life of the battery and the like, is known in the art.

The slurry may further comprise a solvent as desired. Without limitation, solvents such as water, isopropyl alcohol, N-methylpyrrolidone, and acetone may be used, as long as they are known in the art.

Furthermore, the electrode may be a positive electrode or a negative electrode. The positive electrode may comprise a positive electrode current collector and a positive electrode active material layer formed from a positive electrode slurry. Further, the negative electrode may comprise a negative electrode active material layer formed by a negative electrode current collector and a negative electrode slurry.

The positive electrode slurry may comprise a positive electrode active material. The positive electrode active material is not particularly limited, but may include, for example, layered compounds such as lithium cobalt oxide, lithium nickel oxide, or compounds substituted with one or more transition metals; lithium iron oxide such as LiFe₃O₄; lithium manganese oxide of the Equation Li_{1+c}1Mn_{2-c1}O₄ (0≤c1<0.33), LiMnO₃, LiMn₂O₃, or LiMnO₂; lithium manganese oxide, such as Li₂CuO₂; vanadium oxide, such as LiV₃O₈, V₂O₅, or Cu₂V₂O₇; a vanadium oxide of the Equation LiNi_{1-c2}M_{c2}O₂, wherein M is at least one selected from the group consisting of Co, Mn, Al, Cu, Fe, Mg, B, and Ga, and 0.01≤c2≤0.3); a Ni site-type lithium nickel oxide represented by the Equation LiMn_{2-c3}M_{c3}O₂ (where M is at least one selected from the group consisting of Co, Ni, Fe, Cr, Zn, and Ta, and 0.01≤c3<0.1) or a lithium manganese complex oxide represented by Li₂Mn₃MO₈ (wherein M is at least one selected from the group consisting of Fe, Co, Ni, Cu, and Zn); lithium nickel cobalt manganese complex oxide, lithium nickel cobalt manganese aluminum complex oxide, and LiMn₂O₄, wherein portion of the Li in the formula is substituted with an alkaline earth metal ion, are exemplary.

The negative electrode slurry may comprise a negative electrode active material. The negative electrode active material is not particularly limited, but for example, compounds capable of reversible intercalation and deintercalation of lithium may be used. Specific examples include carbonaceous materials such as graphite (artificial, natural, or graphitized carbon fiber) or amorphous carbon; metallic compounds capable of being alloyed with lithium, such as Si, Al, Sn, Pb, Zn, Bi, In, Mg, Ga, Cd, Si alloys, Sn alloys, or Al alloys; SiO_{β} (0<β≤2), SnO2, vanadium oxide, lithium vanadium oxide, and metal oxides capable of doping and de-doping lithium; or composites comprising the above metallic compounds and carbonaceous materials, such as Si—C composites or Sn—C composites, and any one or more mixtures thereof may be used. Also, metallic lithium thin films may be used as the negative electrode active material. As the carbon material, low crystalline carbon and high crystalline carbon may be used. Low crystalline carbons include soft carbons and hard carbons. High crystalline carbons include amorphous, plate, in-plane, spherical or fibrous natural or artificial graphite, Kish graphite, pyrolytic carbon, and mesophase pitch based carbon fiber, mesocarbon microbeads, liquid crystal pitches, mesophase pitches, and high temperature calcined carbons such as petroleum or coal tar pitch derived cokes.

A battery according to one example of the present disclosure may include an electrode and a separator. The battery according to one example of the present disclosure may be a lithium secondary battery. The electrode may be an electrode according to one example of the present disclosure. The battery may comprise a positive electrode and a negative electrode as electrodes. Further, the battery may include a positive electrode, a negative electrode positioned opposite the positive electrode, and a separator positioned between the positive electrode and negative electrode. Further, the battery may include an electrolyte in addition to the positive electrode, negative electrode, and separator.

In a battery according to one example of the present disclosure, at least one selected from the group consisting of the positive electrode and negative electrode may comprise a metal film according to one example of the present disclosure. The at least one selected from the group consisting of the positive electrode and negative electrode may comprise a metal film according to one example of the present disclosure as a current collector.

In a battery according to one example of the present disclosure, where the positive electrode or negative electrode does not comprise a metal film according to one example of the present disclosure, any positive electrode current collector or negative electrode current collector used in the art can be applied without limitation. However, in a battery according to one example of the present disclosure, at least one selected from the group consisting of a positive electrode and a negative electrode comprises a metal film according to one example of the present disclosure.

The type, size, and shape of the positive electrode current collector is not particularly limited, as long as it is conductive without causing chemical changes in the battery. The positive electrode current collector may be, for example, stainless steel, aluminum, nickel, titanium, calcined carbon, or aluminum or stainless steel surface treated with carbon, nickel, titanium, or silver. The surface of the positive electrode current collector can also be formed with microscopic irregularities to increase adhesion to the active material in the positive electrode slurry layer. Furthermore, the positive electrode current collector can be in various forms, such as a film, sheet, foil, net, porous, foam or non-woven material. The current collector may have a thickness of 1 to 500 μm.

The type, size and shape of the negative electrode current collector is not particularly limited, provided that it is conductive without causing chemical changes in the battery. For example, copper, stainless steel, aluminum, nickel, titanium, calcined carbon, copper or stainless steel surface treated with carbon, nickel, titanium, silver, aluminum-cadmium alloys, and the like may be used as the negative electrode current collector. By forming fine irregularities on the surface of the negative electrode current collector, the adhesion to the active material in the negative electrode slurry layer can also be increased. Furthermore, the negative electrode current collector can be in various forms, such as a film, sheet, foil, net, porous, foam or non-woven material. The current collector may have a thickness of 1 to 500 μm.

The separator may separate the positive electrode and negative electrode and provide a migration pathway for lithium ions. The separator can be used without any particular limitation as is common in the art. In particular, it is preferred that the membrane has a low resistance to ion migration in the electrolyte solution while having an excellent wettability of the electrolyte solution. Specifically, porous polymeric films, for example, porous polymeric films made from polyolefin-based polymers such as ethylene polymers, propylene polymers, ethylene/butene copolymers, ethylene/hexene copolymers, and ethylene/methacrylate copolymers, or laminated structures of two or more layers thereof, may be used. Conventional porous nonwoven fabrics may also be used, for example, nonwoven fabrics made of high melting point glass fibers, polyethylene terephthalate fibers, and the like. In addition, coated separators containing ceramic components or polymeric materials for heat resistance or mechanical strength may be used, optionally in a single-layer or multi-layer structure.

The electrolyte contained in the above battery may be an organic liquid electrolyte, an inorganic liquid electrolyte, a gel-type polymer electrolyte, a molten inorganic electrolyte, or the like commonly used in the art, but is not limited thereto. Specifically, the electrolyte may include an organic solvent and a lithium salt.

The organic solvent may be used without limitation as long as it is capable of acting as a medium in which the ions involved in the electrochemical reactions of the battery can move. Specifically, the organic solvents include ester-based solvents such as methyl acetate, ethyl acetate, γ-butyrolactone, ε-caprolactone, and ε-caprolactone; Ether-based solvents, such as dibutyl ether or tetrahydrofuran; Ketone-based solvents, such as cyclohexanone; Aromatic hydrocarbon-based solvents, such as benzene and fluorobenzene; Carbonate solvents, such as dimethylcarbonate, diethylcarbonate, methylethylcarbonate, ethylmethylcarbonate, ethylenecarbonate, and propylene carbonate; alcohol-based solvents, such as ethyl alcohol, isopropyl alcohol, etc.; nitrile groups, such as R—CN (where R is a straight, branched, or cyclic hydrocarbon group of carbon number 2 to 20, which may include a double bonded aromatic ring or ether bond); amide groups, such as dimethylformamide; dioxolane groups, such as 1,3-dioxolane; or sulfolane groups. Among these, carbonate-based solvents are preferred, and mixtures of annular carbonates (e.g., ethylene carbonate or propylene carbonate), which have high ionic conductivity and high dielectric constant, and linear carbonate-based compounds (e.g., ethyl methyl carbonate, dimethyl carbonate, or diethyl carbonate) with low viscosity are more preferred. In this case, a mixture of cyclic carbonate and chain carbonate in a volume ratio of about 1:1 to about 1:9 may result in a better performance of the electrolyte.

The lithium salt may be used without limitation as long as it is a compound capable of providing the lithium ions used in the lithium secondary battery. Specifically, the lithium salts include LiPF₆, LiClO₄, LiAsF₆, LiBF₄, LiSbF₆, LiAlO₄, LiAlCl₄, LiCF₃SO₃, LiC₄F₉SO₃, LiN(C₂F₅SO₃)₂, LiN(C₂F₅SO₂)₂, LiN(CF₃SO₂)₂. LiCl, LiI, or LiB(C₂O₄)₂ may also be used. Preferably, the concentration of the lithium salt is in the range of 0.1 to 2.0 M. When the concentration of the lithium salt is included in the above range, the electrolyte has a suitable conductivity and viscosity, so that it can exhibit good electrolyte performance, and the lithium ions can be effectively transported.

In addition to the above components of the electrolyte, the electrolyte may also contain, for example, haloalkylene carbonate-based compounds such as difluoroethylene carbonate, pyridine, triethyl phosphite, triethanolamine, cyclic ether, ethylenediamine, n-glyme, hexaphosphoric acid triamide, nitrobenzene derivatives, sulfur, quinone imine dyes, N-substituted oxazolidinones, N,N-substituted imidazolidines, ethylene glycol dialkyl ethers, ammonium salts, pyrroles, 2-methoxyethanol, or aluminum trichloride. The additives may be included in an amount of 0.1 to 5 wt % based on the total weight of the electrolyte.

The batteries according to one example of the present disclosure may be at least one or more assembled to form a cell module or cell pack. When the cell module or cell pack comprises a plurality of cells, at least some of the cells may be electrically connected, and the some of the cells may be connected in series or in parallel.

The batteries according to one example of the present disclosure may be included in a portable device, such as a cell phone, laptop computer, digital camera, or other portable device, or in a power unit that provides power for an electric vehicle.

An electric vehicle according to one example of the disclosure may include a battery according to one example of the disclosure.

The structural or functional descriptions of the embodiments in this disclosure are exemplified for the purpose of illustrating embodiments in accordance with the technical ideas of this disclosure only. Further, embodiments in accordance with the technical ideas of this disclosure may be implemented in various forms other than the embodiments described herein, and the technical ideas of this disclosure are not to be construed as being limited to the embodiments described herein.

### Example of Manufacturing a Metal Sheet 200.

The metal sheet 200 was manufactured by electroplating via an electrolytic bath 230 containing an electrolyte 220, a drum 210, and an insoluble electrode plate 240, as shown in FIG. 4. The drum 210 was a titanium drum, and the insoluble electrode plate 240 was a copper plate coated with iridium oxide on its surface.

The composition of the electrolyte 220 is as follows.
Copper: about 80 g/L
Sulfuric acid: about 120 g/L
Gelatin (weight average molecular weight): about 100,000 g/mol

The drum 210 was used as the negative electrode, and the insoluble electrode plate 240 was arranged on the lower surface of the drum 210 as the positive electrode. Then, by immersing them in the electrolyte solution 220 as shown in FIG. 4, electricity was generated between the drum 210 and the insoluble electrode plate 240 under the condition that electricity flows between the drum 210 and the insoluble electrode plate 240, and copper foil of about 10 μm was prepared.
Temperature (temperature of the electrolyte solution): about 50° C.
Current density: about 80 A/dm²

### Example A1

A metal film of about 10 μm was manufactured by transferring the metal sheet 200 manufactured in the above embodiment of the metal sheet 200 through a roller, an electrolytic bath 130 containing the electrolyte 120 and a drum 110.

The drum 110 was a titanium drum. A drum 110 with a diameter of 1 meter was used, and the rotation speed was 30 rpm.

The metal film was prepared by pressing one surface of the metal sheet 200 against the drum 110.

The composition of the electrolyte 120 was as follows.
Copper: about 80 g/L
Sulfuric acid: about 120 g/L
Iodine: 5 mg/L

### Comparative Example A1

The metal sheet 200 prepared in the manufacturing example was used as the metal film 100, i.e., the metal film 100 was prepared without electrolyte 120 treatment.

The data for the metal film prepared above are summarized in Table 1 below. In the following Table 1, Raj is the arithmetic mean roughness of the opposite surface in contact with the drum 110, Ra₂ is the arithmetic mean roughness of the surface in contact with the drum 110, and Ra_{R} is defined as in Equation 1 below. In Table 1 below, the tensile strength was measured by tensile testing after the specimens were fabricated in the form of ASTM E345 metallic thin film tensile test specimens. If the tensile strength is between 10 kg/cm² and 100 kg/cm², it is evaluated as PASS, otherwise it is evaluated as NG. In Table 1 below, the bending resistance test was performed on a rectangular sample with a width of 10 mm and a length of 10 mm using a bending tester (bending radius: 1 mm, bending speed: 100 cpm, stroke: 20 mm) to measure the number of bending cycles until failure according to the measurement method of JIS C 5016. If the number of bending cycles was more than 3,000, it was evaluated as PASS, and if it was less than 3,000, it was evaluated as NG.

Ra_{R}=Ra₁/Ra₂×100 [Equation 1].

TABLE 1

| Classifi- | Arithmetic Mean Roughness | | | Tensile strength | Flexural |
|---|---|---|---|---|---|
| cation | Ra₁ | Ra₂ | Ra_{R} | (kg/cm²) | Test |
| Example A1 | 0.56 | 0.075 | 747 | PASS | PASS |
| Comparative | 0.05 | 0.1 | 50 | NG | NG |
| Example A1 | | | | | |

### Example B1

A slurry was applied to both surfaces of the metal film prepared in Embodiment A1 above to a uniform thickness, dried, and rolled to produce a negative electrode. The slurry was prepared by mixing the negative electrode active material A, the coating material B, the styrene-butadiene rubber C, and the carboxylmethyl cellulose D in a weight ratio of 93.5:3:1.5:2 (A:B:C:D) and dispersing them sufficiently in a solvent. The negative electrode active material A was a mixture of artificial graphite A1 and natural graphite A2 in a weight ratio of 7:3 (A1:A2). The solvent D was water.

A SKIET's separator was placed between the negative electrode and positive electrode prepared above, and a jelly roll was made from it to prepare the electrode assembly. Lithium foil was used as the positive electrode. Then, the electrode assembly was placed in the case, sealed, and electrolyte was injected into the case to make a mono-cell. The electrolyte injected into the case was a lithium non-aqueous electrolyte solution comprising a mixture of ethyl carbonate and ethyl methyl carbonate in a volume ratio of 3:7 and about 1 M of lithium salt (LiPF₆).

### Comparative Example B1

A negative electrode and a mono-cell containing the negative electrode were prepared in the same manner as in Comparative Example B1, except that instead of the metal film prepared in Comparative Example A1 above, the metal film prepared in Comparative Example A1 above was used.

The data for the mono-cells prepared as described above are summarized in Table 2 below.

The electrical behavior of the above mono cells was verified by each RPT (Reference performance test). In the above RPT, the capacity is the value of the discharge capacity measured at the last three discharges after repeating the charge and discharge three times under 1 C-1 C charge and discharge conditions. In addition, during the 1 C-1 C charge-discharge condition, the charge was performed under the CCCV (Constant Current Constant Voltage) protocol with 4.2V and 20 A, and the cut-off current was set to 1 A. The discharge was then performed after a resting period of 10 minutes. During the above charge and discharge conditions, the discharge was performed at 20 A under CC (Constant Current) protocol and the cut-off voltage was set to 2.5V.

The repetition of charge and discharge is defined as one cycle or loop of the above charge condition—10 minutes of resting—the above discharge condition—10 minutes of resting.

In the above RPT, the resistance R was calculated by applying a discharge current of 20 A for 10 seconds when the SOC (State of Charge) is 50%, and then calculating R=(voltage difference at 10 second intervals)/discharge current.

In Table 1, 500 Fast Charge Cycles after Fast Charge Cycle means 500 times of charging (100 A to reach SOC 40%, 50 A to reach SOC 60%, 30 A to reach SOC 70%, and cut-off at SOC 80%), followed by 10 minutes of resting, followed by discharging (20 A under CC condition, cut-off voltage is 2.5V) and 10 minutes of resting, defined as one cycle, repeated 500 times. The capacity of the mono-cell is then expressed as a percentage of the capacity under RPT conditions.

TABLE 2

| | | | | Fast Charge |
|---|---|---|---|---|
| | RPT | | 1 C-1 C cycle @ | Cycle after |
| Category | Capacity | Resistance | 25° C. | 500 cycles |
| Example B1 | 20 Ah | 10 mohm | 2000 cycles | 90% |
| | | | | (no plating) |
| Comparative | 20 Ah | 13 mohm | 1500 cycles | 75% |
| Example B1 | | | | (plating occur) |

The above described is merely an example of applying the principles of the present disclosure, and other configurations may be included without departing from the scope of the present disclosure.

The description of the present disclosure is for illustrative purposes only, and a person skilled in the art to which the present disclosure pertains will understand that the present disclosure may be easily modified into other specific forms without changing the technical idea or essential features of the present disclosure. Therefore, it should be understood that the embodiments described above are exemplary in all respects and not limiting. For example, each component described as a single entity may be implemented in a distributed manner, and likewise, components described as distributed may be implemented in a combined manner.

The scope of the present disclosure is indicated by the appended claims rather than the detailed description above, and all changes or modifications derived from the meaning and scope of the claims and their equivalent concepts should be construed as being in the scope of the present disclosure.

What is claimed is:

1. A metal film comprising:
a first surface; and
a second surface opposite to the first surface;
wherein the metal film has Ra_{R} defined by the following Equation 1 in the range of 100 to 2,000,
Ra_{R}=Ra₁/Ra₂×100, [Equation 1]
where the Ra₁ denotes the arithmetic mean roughness of the first surface and the Ra₂ denotes the arithmetic mean roughness of the second surface.

2. The metal film according to claim 1, wherein the metal film is included in the current collector of a battery.

3. The metal film according to claim 1, wherein the metal film has a tensile strength in the range of 10 kg/cm² to 100 kg/cm².

4. The metal film according to claim 1, wherein the metal film has a bending number of at least 3,000 times until fracture.

5. The metal film according to claim 1, further comprising: a halogen element.

6. The metal film according to claim 5, wherein the halogen element comprises at least one selected from the group consisting of chlorine and iodine.

7. The metal film according to claim 6, wherein the metal film comprises chlorine in the range of 1 wt % to 30 wt % by total weight.

8. The metal film according to claim 6, wherein the metal film comprises iodine in the range of 0.001 wt % to 0.1 wt % by total weight.

9. The metal film according to claim 1, wherein crystal grains are formed on the first and second surfaces.

10. The metal film according to claim 1, further comprising: copper or aluminum.

11. A method of manufacturing a metal film, comprising:
a step of contacting at least a portion of a metal sheet including a first surface and a second surface opposite to the first surface with a first electrolyte solution containing metal ions and withdrawing out the metal film;
wherein the metal film has Ra_{R} defined by the following Equation 1 in the range of 100 to 2,000,
Ra_{R}=Ra₁/Ra₂×100, [Equation 1]
where the Ra₁ denotes the arithmetic mean roughness of a first surface of the metal film and the Ra₂ denotes the arithmetic mean roughness of a second surface of the metal film.

12. The method according to claim 11, wherein the first surface of the metal sheet reacts with the first electrolyte solution.

13. The method according to claim 11, wherein the second surface of the metal sheet is not substantially reactive with the first electrolyte solution.

14. The method according to claim 11, wherein the metal ions contained in the first electrolyte solution are aluminum ions or copper ions, the first electrolyte solution further comprises at least one selected from the group consisting of chlorine ions and iodine ions.

15. The method according to claim 14, wherein the first electrolyte solution comprises chlorine ions in the range of 0.1 mg/L to 1 mg/L.

16. The method according to claim 14, wherein the first electrolyte solution comprises iodine ions in the range of 1 mg/L to 10 mg/L.

17. The method according to claim 11, wherein the metal sheet is prepared by electroplating with a second electrolyte solution containing metal ions.

18. The method according to claim 17, wherein the second electrolyte solution further comprises gelatin.

19. An electrode comprising:
a current collector; and
an active material layer formed on at least one surface of the current collector;
wherein the current collector comprises the metal film of claim 1.
